(19) United States
(12) Patent Application Publication
(10) Pub. No.: US 2016/0083240 A1
(43) Pub. Date: Mar. 24, 2016

(54) Beer keg platform

(71) Applicants: John M. Macor, Hunterdon County, NJ (US); Richard J. Macor, Hunterdon County, NJ (US)

(72) Inventors: John M. Macor, Hunterdon County, NJ (US); Richard J. Macor, Hunterdon County, NJ (US)

(21) Appl. No.: 14/121,582

(22) Filed: Sep. 19, 2014

(51) Int. Cl. B67D 1/08; A47B 13/02; A47B 13/00

(52) U.S. Cl. CPC B67D 1/0894; A47B 13/003; A47B 13/02

(57) ABSTRACT

A platform configured for use atop a beer keg while a pressurizing attachment is attached to the beer keg. The beer keg has a top formed with predetermined dimensions including a maximum across-width dimension. The pressurizing attachment is formed with predetermined dimensions. The platform is one piece with a substantially thin and flat form. The platform also has a top, a bottom, and a maximum across-width dimension greater than the maximum across-width dimension of the top of the beer keg. The platform has an opening formed and positioned therein with a size and shape that provides sufficient space for the pressurizing attachment while the pressurizing attachment is attached to the beer keg. And, the platform requires no assembly for the use thereof atop the beer keg.

### FIELD OF THE INVENTION

The present invention relates to beer kegs, and more particularly to beer keg accessories.

### BACKGROUND OF THE INVENTION

Beer Kegs have been around for many years and the modern traditional version is cylindrically shaped with an upper rim or periphery and provision for a pressurizing device such as a keg pump. The pressurizing device is usually attached at the top of the keg and used to pressurize the keg to evacuate dispensed beer. Since a beer keg dispenses large volumes of beer, it's cost-efficient for large parties or social gatherings. Many cups or pitchers of beer may be filled from a single beer keg, yet there is no provision for the placement of beer containers such as cups, glasses, mugs, pitchers, etc.

The inventors herein contemplate a simple, inexpensive, highly functional device for use with a beer keg, which provides for the temporary placement of beer containers such as cups, glasses, mugs, pitchers, etc., while a pressurizing attachment such as a keg pump is attached to the beer keg.

### SUMMARY OF THE INVENTION

In one example embodiment, the present invention is a platform formed for use atop a beer keg. The beer keg has predetermined dimensions including a maximum across-width dimension, and, provision for a pressurizing attachment. The pressurizing attachment has predetermined dimensions. The platform is formed substantially thin and flat with a top, a bottom, and a maximum across-width dimension greater than the maximum across-width dimension of the beer keg. The platform further has an opening formed therein providing clearance for the pressurizing attachment while the pressurizing attachment is attached to the beer keg.

Accordingly, it is an objective of the present invention beer keg platform described herein that it provide for the temporary placement of beer containers such as glasses, mugs, cups and pitchers etc., while a pressurizing attachment such as a keg pump is attached to the beer keg.

It is another objective of the present invention platform described herein, that it be securable and/or attachable above and/or upon a beer keg, while a pressurizing attachment such as a keg pump is attached to the beer keg.

And, it is another objective of the present invention platform described herein, that it be commercially viable, simple in design, and cost-efficient to manufacture.

### BRIEF DESCRIPTION OF THE DRAWINGS

The present invention is more fully understood when the specification herein is taken in conjunction with the drawings appended hereto, wherein:

FIG. 1 shows a side cut view of a typical beer keg with an attached keg pump, and a present invention beer keg platform;

FIGS. 2, 3 and 4 show a top perspective view, bottom view, and side view respectively of an example embodiment of a present invention beer keg platform;

FIGS. 5, 6 and 7 show a top perspective view, bottom view, and side view respectively of another example embodiment of a present invention beer keg platform;

FIGS. 8, 9 and 10 show a top perspective view, bottom view, and side view respectively of another example embodiment of a present invention beer keg platform;

FIGS. 11, 12 and 13 show a top perspective view, bottom view, and side view respectively of another example embodiment of a present invention beer keg platform; and,

FIG. 14 shows a side cut view of a typical beer keg with an attached keg pump, and a present invention beer keg platform above the keg with beer cups and a pitcher placed thereon.

### DETAILED DESCRIPTION OF THE DRAWINGS

The various drawings provided herein are for the purpose of illustrating examples of the present invention and not for the purpose of limiting same. Therefore, the drawings herein represent only a few of the many possible examples, embodiments, variations and/or applications of the present invention.

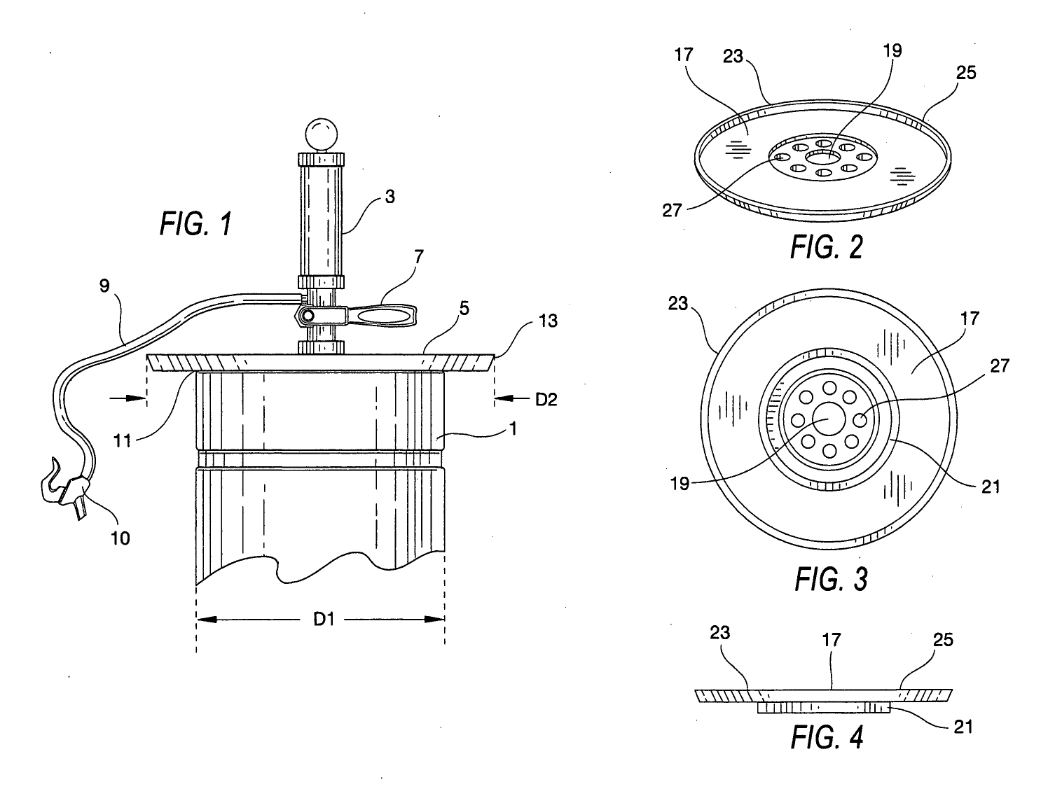

FIG. 1 shows a side cut view of a typical beer keg 1 with an attached keg pump 3 and a present invention keg platform 5. Keg pump 3 has a locking handle 7, and a hose 9 with a faucet 10. Keg platform 5 is configured for use above beer keg 1. In this embodiment of the present invention, keg platform 5 is configured for use directly upon keg 1, however in other embodiments, the present invention keg platform could also be positioned upon one or more spacers, brackets or supporting device(s) upon keg 1. Since an objective of the present invention is that it be simple in design and cost-efficient to manufacture, preferred embodiments of the present invention beer keg platform would be a single piece positioned upon and supported by the keg without the need for additional spacers, brackets, or other supporting device(s). Beer keg 1 has predetermined dimensions (based upon model and version, etc.) including a maximum across-width dimension D1, and, provision for a pressurizing attachment not seen in this view. Pressurizing attachment 3 has predetermined dimensions (based upon the model and version etc.) Keg platform 5 also has predetermined dimensions including a maximum across-width dimension D2. Platform 5 also has an opening configured therein providing clearance for pressurizing attachment 3 while pressurizing attachment 3 is attached to beer keg 1. Note, the platform opening is not seen in this view, however clearly illustrated in the sample embodiments shown in FIGS. 2, 3, 5, 6, 8, 9, 11 and 12. As shown in this view, platform 5 has an across-width dimension D2 substantially greater than the across-width dimension D1 of keg 1. Platform 5 is configured this way to provide for the temporary placement of beer containers such as cups, mugs, glasses and pitchers. Accordingly, preferred embodiments of the present invention keg platform will have a maximum across-width dimension equal to or greater than the maximum across-width dimension of the beer keg below it.

FIGS. 2, 3 and 4 together show a top perspective view, bottom view, and side view respectively of an example embodiment of a present invention keg platform 17. Keg platform 17 is configured for use above a beer keg, and has an opening 19 configured therein providing clearance for a pressurizing attachment such as a keg pump. Opening 19 provides for the utilization of platform 17 while a pressurizing attachment such as a keg pump is attached to a beer keg, as shown and described in FIGS. 1 and 14. Platform 17 has a bottom protruding rim 21 seen best in FIGS. 3 and 4 that is sized to fit snugly inside the upper rim of a standard to secure platform 17 upon the beer keg. Preferred embodiments of the present invention keg platform include means by which the platform may be secured upon a beer keg. Such means could include any structural means by which platform 17 prohibits lateral and/or vertical movement above and/or upon a beer keg. Some preferred embodiments of the present invention will comprise at least one protrusion at the bottom of the platform, such as protrusion 21 of platform 17, to secure the keg platform and prohibit lateral movement of the platform above the beer keg. Platform 17 also has functional features specific to usage including a group of drainage holes such as hole 27, providing means to control draining of beer spillage. Platform 17 also has an outer periphery 23 which is formed as a raised rim 25 to contain beer spillage from spilling outside of periphery 23.

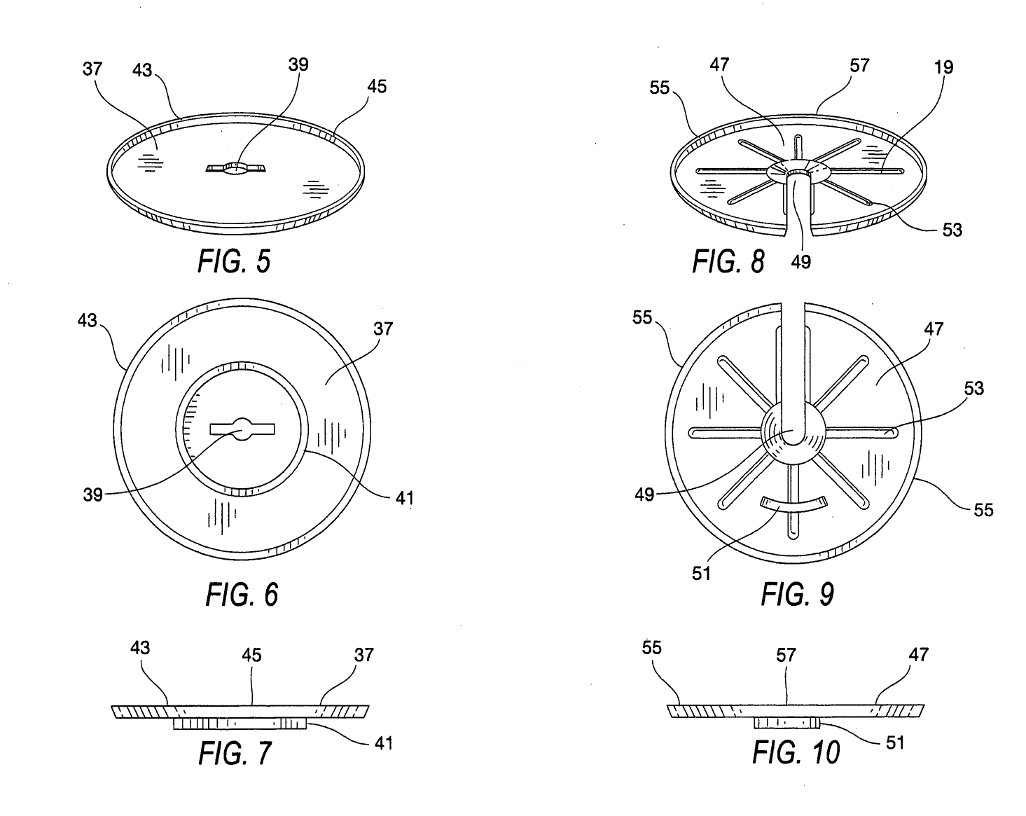

FIGS. 5, 6 and 7 together show a top perspective view, bottom view, and side view respectively of another example embodiment of a present invention keg platform 37. Keg platform 37 is configured for use above a beer keg, and has an opening 39 configured therein providing clearance for a pressurizing attachment such as a keg pump. Opening 39 provides for the utilization of keg platform 37 while a pressurizing attachment such as a keg pump is attached to a beer keg, as shown and described in FIGS. 1 and 14. In this embodiment of the present invention, keg platform 37 is configured for use directly upon a beer keg, however in other embodiments, the present invention keg platform could also be positioned upon one or more spacers, brackets or supporting device(s) in between keg platform 37 and the keg. Since an objective of the present invention is that it be simple in design and cost-efficient to manufacture, preferred embodiments of the present invention beer keg platform would be a single piece configured for positioning upon a beer keg without the need for additional spacers, brackets, or other supporting device(s). In this embodiment of the present invention, keg platform opening 39 is elongated so that platform 37 may be placed down over a pressurizing device such as the keg pump shown in FIGS. 1 and 14. The elongated opening allows platform 37 to pass down over the keg pump handle and hose without removing the keg pump. Accordingly, some preferred embodiments of the present invention include an elongated opening. Keg Platform 37 also has a bottom protruding rim 41 seen best in FIGS. 6 and 7 that is sized to fit snugly inside the upper rim of a keg to secure platform 37 upon the beer keg. Preferred embodiments of the present invention keg platform include means by which the keg platform may be secured upon a beer keg. Such means could include any structural means by which platform 37 prohibits lateral and/or vertical movement above and/or upon a beer keg. Accordingly, some preferred embodiments of the present invention will comprise at least one protrusion at the bottom of the platform, such as protrusion 41 of platform 37, to secure the keg platform and prohibit lateral movement of the platform above the beer keg. Platform 37 also has an outer periphery 43 which is formed as a raised rim 45 to contain beer spillage from spilling outside of periphery 43.

FIGS. 8, 9 and 10 together show a top perspective view, bottom view, and side view respectively of another example embodiment of a present invention keg platform 47. Keg platform 47 is configured for use above a beer keg, and has an opening 49 configured therein providing clearance for a pressurizing attachment such as a keg pump. Opening 49 provides for the utilization of platform 47 while a pressurizing attachment such as a keg pump is attached to a beer keg as shown and described in FIGS. 1 and 14. In this embodiment of the present invention, opening 49 is elongated and open-ended so that platform 47 may be slid laterally upon a keg and around a keg pump, under the handle and hose as shown in FIGS. 1 and 14. Accordingly, some preferred embodiments of the present invention include an elongated opening which may, or may not be, open-ended. Some embodiments of the present invention keg platform are structured for installation prior to the keg pump being attached to the keg such as the embodiment shown in FIGS. 2, 3 and 4. Preferred embodiments of the present invention keg platform are structured for installation prior to and/or after the keg pump is attached to the keg such as the embodiments shown in FIGS. 5, 6, 7, 8, 9, 10 11, 12, and 13. Platform 47 has a protrusion 51 best seen in FIGS. 9 and 10 protruding from the bottom to prohibit lateral movement of platform 47 upon a beer keg. Platform 47 is slid laterally upon the keg by way of opening 49 providing clearance for the keg pump. When the end of opening 49 contacts the pump base (under the pump handle and hose) the platform is dropped down and protrusion 51 fits snugly inside the top rim of the keg securing platform 47 substantially centered upon a beer keg such as that shown in FIGS. 1 and 14. Preferred embodiments of the present invention keg platform include means by which the platform may be secured upon a beer keg. Such means could include any structural means that prohibits lateral and/or vertical movement of platform 47 upon a beer keg. Accordingly, some preferred embodiments of the present invention will comprise at least one protrusion at the bottom of the platform, such as protrusion 51 of platform 47, to secure the keg platform and prohibit lateral movement of the platform above the beer keg. Platform 47 also has functional features specific to usage including a group of drainage channels such as channel 53 seen best in FIGS. 8 and 9, whereby platform 47 has means to control draining of beer spillage. Platform 47 also has an outer periphery 55 which is formed as a raised rim 57 to contain beer spillage from spilling outside of periphery 55.

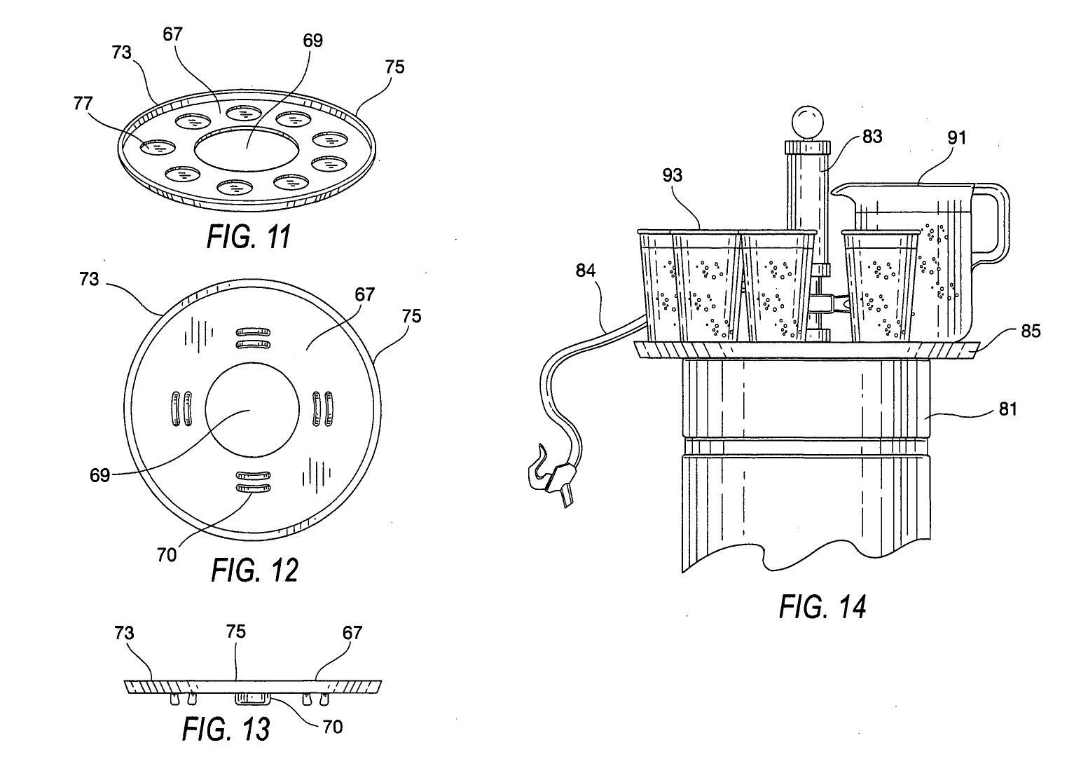

FIGS. 11, 12 and 13 together show a top perspective view, bottom view, and side view respectively of another example embodiment of a present invention keg platform 67. Keg platform 67 is configured for use above a beer keg, and has an opening 69 configured therein providing clearance for a pressurizing attachment such as a keg pump. Opening 69 provides for the utilization of platform 67 while a pressurizing attachment such as a keg pump is attached to a beer keg as shown and described in FIGS. 1 and 14. In this embodiment of the present invention keg platform opening 69 is large and round to facilitate installation of platform 67 before and/or after a keg pump is attached to a keg. If the keg pump is already attached to the keg, platform 67 may be placed down over the keg pump including its handle and hose and positioned substantially center upon a keg such as that shown in FIGS. 1 and 14. Platform 67 has a bottom with four sets of two protrusions such as protrusion 70 formed to pinch and frictionally attach platform 67 to an upper rim of a keg. The protrusions are positioned and spaced apart based upon the predetermined dimensions of the beer keg intended for use. Preferred embodiments of the present invention keg platform include means by which the platform may be secured upon a beer keg. Such means could include any structural means that prohibits lateral and/or vertical movement of platform 67 upon a beer keg. Some preferred embodiments of the present invention are provided means for detachable attachment with said beer keg. The present invention keg platform could be detachably attached to a beer keg by many different means including friction, nuts, bolts, fasteners, clips, wire, rope, tie-downs, Velcro, etc. Accordingly, some preferred embodiments of the present invention will include at least one protrusion at the bottom of the platform, such as 70 which is one of the four pairs of protrusions formed for detachable attachment with an upper rim of a beer keg. Platform 67 also has an outer periphery 73 which is formed as a raised rim 75 to contain beer spillage from spilling outside of periphery 73. Platform 67 is also formed with means to secure a container of beer such as a cup, glass or mug. Circular depressions such as circular depression 77 seen in FIG. 11 are formed to better secure a beer cup, glass or mug upon platform 67.

FIG. 14 shows a side cut view of a typical beer keg 81 with an attached keg pump 83 and a present invention keg platform 85. Keg pump 83 has a locking handle partially blocked from view in the Figure, and a hose 84. Keg platform 85 is configured for use above beer keg 81 and for the temporary placement of beer containers such as beer cups such as beer cup 93, glasses, mugs and pitchers such as pitcher 91. Pressurizing attachment 83 has predetermined dimensions (based upon the model and version etc.) Keg platform 85 also has an opening configured therein providing clearance for pressurizing attachment 83 while pressurizing attachment 83 is attached to beer keg 81. Note, the platform opening is not seen in this view, however clearly illustrated in the sample embodiments shown in FIGS. 2, 3, 5, 6, 8, 9, 11 and 12.

The present invention is a keg platform configured for the temporary placement of beer containers such as beer cups, glasses, mugs, pitchers etc., while, a pressurizing attachment such as a keg pump is attached to the beer keg. The keg platform could be made from a variety of different materials including aluminum, steel, alloys, wood, plastic, etc. In most cases the present invention platform would likely be molded and/or machined from a plastic or plastic-like material.

As can been seen in all the drawing FIGS. 1-14, each example embodiment of the present invention is a platform formed for use atop a beer keg, and, each platform is formed substantially thin and flat. And, as shown in all the FIGS. 1-14, particularly in FIGS. 1 and 14, preferred embodiments of the present invention do not rely upon an outer side wall or outer peripheral structure to provide support for the platform atop a beer keg.

Upon reading and understanding the specification of the present invention described above, modifications and alterations will become apparent to those skilled in the art. It is intended that all such modifications and alterations be included insofar as they come within the scope of the patent as claimed or the equivalence thereof.

1-40. (canceled)

41. A platform configured for use atop a beer keg while a pressurizing attachment is attached to said beer keg; the beer keg having a top formed with predetermined dimensions including a maximum across-width dimension; the pressurizing attachment formed with predetermined dimensions; said platform comprising:
a one piece, substantially thin and flat form;
a top, a bottom, and a maximum across-width dimension;
said maximum across-width dimension being greater than the maximum across-width dimension of the top of said beer keg;
an opening formed and positioned therein with a size and shape providing sufficient space for the pressurizing attachment while the pressurizing attachment is attached to said beer keg; and,
said platform requiring no assembly for the use thereof atop said beer keg.

42. The platform according to claim 41, wherein, the bottom of said platform is formed with means to engage and interlock with the top of said beer keg by utilizing the form and predetermined dimensions of the top of said beer keg, to prohibit lateral movement of said platform atop said beer keg.

43. The platform according to claim 41, wherein, said platform is substantially round.

44. The platform according to claim 41, wherein, the platform opening is elongated.

45. The platform according to claim 41, wherein, said platform has a periphery, and at least a portion of the periphery is formed as a raised rim.

46. The platform according to claim 41, wherein, said platform comprises at least one opening for draining beer spillage.

47. The platform according to claim 42, wherein, there is at least one protrusion protruding out from the bottom of said platform to engage and interlock with the top of said beer keg by utilizing the form and predetermined dimensions of the top of said beer keg, to prohibit lateral movement of said platform atop said beer keg.

48. The platform according to claim 44, wherein, said platform has a periphery, and, said elongated opening extends to said periphery.

49. A combination of a beer keg, a pressurizing attachment, and a platform configured for use atop the beer keg while the pressurizing attachment is attached to said beer keg; the combination comprising:
said beer keg having a top formed with predetermined dimensions including a maximum across-width dimension;
said pressurizing attachment formed with predetermined dimensions;
said platform being formed substantially thin and flat with a top, a bottom, and a maximum across-width dimension greater than the maximum across-width dimension of the top of said beer keg, said platform having an opening formed and positioned therein with a size and shape providing sufficient space for the pressurizing attachment while the pressurizing attachment is attached to said beer keg.

50. The combination of a beer keg, a pressurizing attachment, and a platform according to claim 49, wherein, said platform is a one piece requiring no assembly for the use thereof atop said beer keg.

51. The combination of a beer keg, a pressurizing attachment, and a platform according to claim 49, wherein, the bottom of said platform is formed with means to engage and interlock with the top of said beer keg by utilizing the form and predetermined dimensions of the top of said beer keg, to prohibit lateral movement of said platform atop said beer keg.

52. The combination of a beer keg, a pressurizing attachment, and a platform according to claim 49, wherein, said platform is substantially round.

53. The combination of a beer keg, a pressurizing attachment, and a platform according to claim 49, wherein, the platform opening is elongated.

54. The combination of a beer keg, a pressurizing attachment, and a platform according to claim 49, wherein, said platform has a periphery, and at least a portion of the periphery is formed as a raised rim.

55. The combination of a beer keg, a pressurizing attachment, and a platform according to claim 49, wherein, said platform comprises at least one opening for draining beer spillage.

56. The combination of a beer keg, a pressurizing attachment, and a platform according to claim 50, wherein, the bottom of said platform is formed with means to engage and interlock with the top of said beer keg by utilizing the form and predetermined dimensions of the top of said beer keg, to prohibit lateral movement of said platform atop said beer keg.

57. The combination of a beer keg, a pressurizing attachment, and a platform according to claim 50, wherein, said platform is substantially round.

58. The combination of a beer keg, a pressurizing attachment, and a platform according to claim 50, wherein, the platform opening is elongated.

59. The combination of a beer keg, a pressurizing attachment, and a platform according to claim 51, wherein, there is at least one protrusion protruding out from the bottom of said platform to engage and interlock with the top of said beer keg by utilizing the form and predetermined dimensions of the top of said beer keg, to prohibit lateral movement of said platform atop said beer keg.

60. The platform according to claim 53, wherein, said platform has a periphery, and, said elongated opening extends to said periphery.
